(19) United States
(12) Patent Application Publication
(10) Pub. No.: US 2005/0023410 A1
(43) Pub. Date: Feb. 3, 2005

(54) Multipurpose airfoil assembly

(76) Inventor: Barry Pinchefsky, New York, NY (US)

Correspondence Address: Stephen E. Feldman, P.C., 12 East 41st Street, New York, NY, 10017, US

(21) Appl. No.: 10/286,290

(22) Filed: Nov. 1, 2002

(51) Int. Cl. B64C 27/22

(52) U.S. Cl. 244/10

(57) ABSTRACT

The present disclosure describes a multipurpose airfoil assembly including a body, at least one pair of wings, and a control system. The body provides a structural connection for the wings. At least one of the pairs of wings has forward swept leading edges and forward swept trailing edges. The shape of the airfoil assembly can range from that of a traditional airframe to a natural leaf like structure. The airfoil assembly can also include a rudder. A control system is provided for directionally controlling the airfoil assembly during its operation. The airfoil assembly can be readily adapted to configurations suitable for a kite, a hang glider, a parachute, and a sail.

### BACKGROUND

1. Technical Field

The present disclosure relates to airfoils having application in multiple lifting apparatuses. More particularly, the present disclosure relates to airfoil assemblies having wing shapes providing advantageous aerodynamic attributes.

2. Background of Related Art

Airfoils have a broad spectrum of shapes tailored for their specific applications. As one example, a kite typically has a thin lightweight fabric airfoil stretched tightly between structural members. A parachute, in contrast is light weight, but is packaged for rapid expansion and has the strength to safely decelerate a decent. The stresses a sail undergoes during its use are similarly distinct. While many modem sails are fabricated of man made light weight materials such as nylon and composites, sails are often still made of durable sail cloth. In each application, the material of the airfoil requires suitable strength environmental endurance, and support from a structure for its intended application.

Kites have had a broad range of novel structures and attributes over the years. In U.S. Pat. No. 1,425,419 to Reid, a kite with a star shaped appearance and a movable flap or apron is provided. The apron is provided. The apron is adapted to vibrate and create a humming sound when the kite is aloft. Several other patents show innovative kite configurations in which the kites are distinguished solely by subtle engineering innovations. For example U.S. Pat. No. 5,000,401 to Barone shows a rigid kite having a heart or star shape airfoil. Another, U.S. Pat. No. 1,782,858 to Nagy, also teaches a star configuration having radial ribs and a cord strand with a plurality of loops enclosing the ends of the ribs.

Kites having controllable or variable airfoils include U.S. Pat. No. 4,280,675 to Davis et al and U.S. Pat. No. 5,556,057 to Davies which employ control lines to adjust the frame and thus aerodynamic attributes of the kite. Each of these kites, however, are limited by their configuration and don not have aerodynamically enhancing lift attributes configured to support flight and/or maneuverability in the light wind conditions that frequently occur with kites.

Flight under reduced wind conditions can also occur in hang-gliders which typically employ conventional wing structures and varying means to establish directionally controlled flight. In U.S. Pat. No. 6,293,420 to Davies, for example, a hang-gliders is provided with a flexible wing preferably positioned over a pilot's position from which the aircraft can be controlled through foot pedals actuating the trailing edges of the flexible wings. The wing has a traditional aft swept configuration, however, which is limited in its ability to sustain flight in higher angles of attack and at reduced airspeeds.

Many innovative adjustments have also been made to the basic parachute. U.S. Pat. No. 2,365,230 to Volf shows another inventive parachute having a circular canopy with a centrally located internal cone and a series of diagonal air vent panels. This canopy design utilizes diagonally positioned vents which, when opened progressively, relieve excess air pressure. U.S. Pat. No. 3,420,478 to Ferguson teaches a square parachute having air confining members comprising a piece of material with a plurality of securing strips that channel the air captured by the opened into the parachute. The air confining members contribute to the overall efficiency and safety of the basic parachute and along with other attributes are suited for low altitude air drops. Both of these innovations focus on enhancing the air captured by the opened parachute, however, both Volf and Ferguson lack the flexibility that can be imparted by a parachute having lift enhancing shapes.

Another airfoil, the sail, has had demanding requirements for an airfoil including resisting deterioration from salt spray, chafing, and other environmental factors. One goal of modern sails is to create a lightweight and flexible air foil that will maintain its desired aerodynamic shape through a chosen wind range.

U.S. Pat. No. 6,302,044 to Baudet teaches an approach to sail construction for economy and the minimizing of undesirable stretching. Baudet focuses primarily on larger type high performance sails. Similarly, U.S. Pat. No. 6,332,420 to Rodgers describes a sail making process involving molding yarns positioned to radiate from each corner of the sail with at least some of the yams extending to and terminating at an opposite edge of the sail. At least some of the yams are in a geodesic type pattern, in that they follow the shortest path between two points on a 3-D surface. It is believed this enhances the strength of the sail. Neither of these patents, however, addresses the ability of a sail to enhance performance under light wind.

A continuing need exists for multipurpose airfoil assembly that can be adapted for use in a range of applications in which its aerodynamic improvements can be advantageously employed.

### SUMMARY

A multipurpose airfoil assembly is provided comprising a body, at least one pair of wings, and control system. The body and wings defining a leaf shaped airfoil. The body has a first end and a second end, a structure, and a skin. The first end and the second end define a longitudinal axis. The structure has at least one member aligned to the longitudinal axis. The wings include a wing structure and a wing airfoil with one of the pairs of wings having a forward swept leading edge and a forward swept trailing edge. The control system is configured for controlling the directional movement of the airfoil assembly. The control system suitably connects the airfoil assembly with a person for directional control.

The invention, together with attendant advantages, will be best understood by reference to the following detailed description of the invention when used in conjunction with the figures below.

### BRIEF DESCRIPTION OF THE DRAWINGS

Preferred embodiments of the presently disclosed multipurpose airfoil are described herein with reference to the drawings, wherein:

FIG. 1 is an aft perspective view of one preferred embodiment of a multipurpose airfoil constructed in accordance with the present disclosure.

FIG. 2 is a bottom view of one preferred embodiment of a multipurpose airfoil kite constructed in accordance with the present disclosure.

FIG. 3 is a bottom view of a second preferred embodiment of a multipurpose airfoil kite constructed in accordance with the present disclosure.

FIG. 4 is a frontal perspective view of one preferred embodiment of a multipurpose airfoil hang glider constructed in accordance with the present disclosure.

FIG. 5 is a frontal perspective view of one preferred embodiment of a multipurpose airfoil parachute constructed in accordance with the present disclosure.

FIG. 6 is a frontal view of one preferred embodiment of a multipurpose airfoil sail constructed in accordance with the present disclosure; and

FIG. 7 is a frontal view of a second preferred embodiment of a multipurpose airfoil sail constructed in accordance with the present disclosure.

### DETAILED DESCRIPTION OF THE EMBODIMENTS

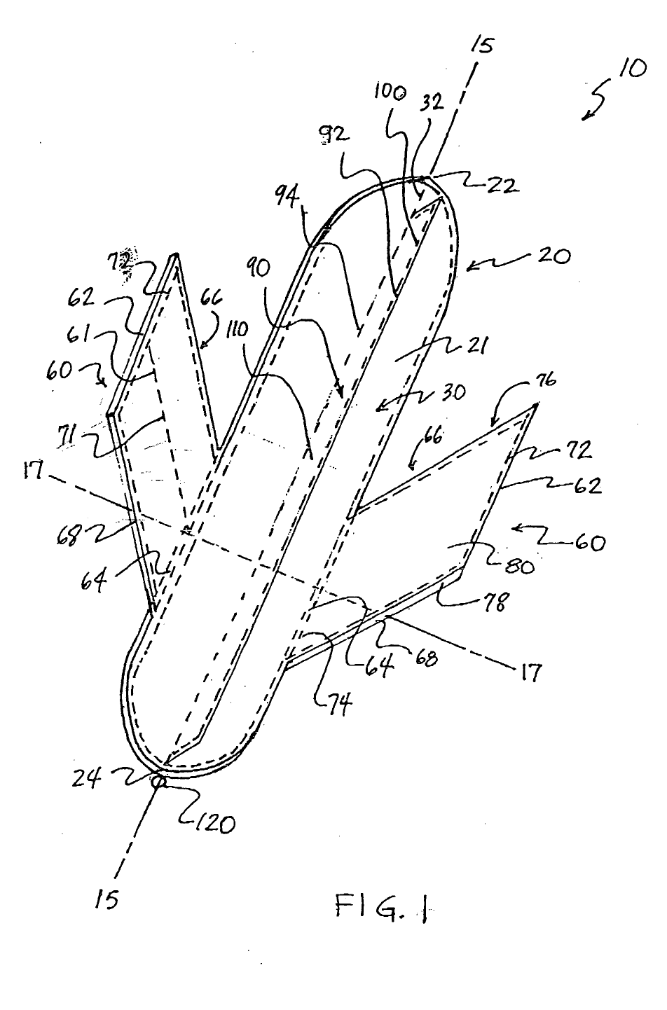

Referring now in specific detail to the drawings in which like referenced numerals identify similar or identical elements throughout the several view, and initially to FIG. 1, a novel airfoil assembly 10 having a body 20, wings 60, and a control system 120 is shown constructed in accordance with the present disclosure.

Body 20 has a first end 22 and a second end 24. First end 22 and second end 24 define a first longitudinal axis 15 and a second longitudinal axis 17 perpendicular to first longitudinal axis 15. The intersection of first axis 15 and second axis 17 defines a first plane. Second end 24 is directionally defined as aft and first end 22 is directionally defined as forward, as commonly used in aeronautical terms. Body 20 has a first side 21, preferably oriented into the relative wind, and an opposing second side (not shown). Body 20 includes a structure 30 and an airfoil or skin 40. Structure 30 has a member 32 defining a centerline of body 20. Member 32 and additional supporting structural elements 34 of structure 30 define a shaping framework for airfoil 40 configured to accommodate the varying applications of airfoil assembly 10. Body 20 can vary from primarily being a centerline positioned between wings to a fuselage type shape. Body 20 can be a lifting or a non-lifting body.

Wings 60 have a wing structure 70 and a wing airfoil 80. At least one pair of wings 60 has a forward sweep. Forward sweep is defined herein as the leading the leading the trailing edges of the wings being swept in the direction of forward of a line perpendicular to the longitudinal axis of the airfoil.

Each wing 60 includes a tip 62, a root 64, a leading edge 66, and a trailing edge 68. Roots 64 are connected to structure 30. Structure 70 defines spars 72 and 74 as the structural elements associated with wing tips and wing roots and members 76 and 78 as the structural elements for leading edges 66 and trailing edges 68, respectively. Wings 60 can be generally planar with minimal third dimension, as shown, or include a camber suitable for providing additional lift. The length of wings 60 can vary depending upon the application and can include a varying quantity of spars positioned between spars 72 and 74. Spars 72 and 74 are positioned to connect members 76 and 78 and can assist in shaping of the structural framework of wing 60 by defining attributes of the wing such as the camber and width of each wing 60.

As an alternative structure, wings 60 can have a member 71 approximately positioned on a centerline 61 of the wing. Spars 72 and 74 are configured to extend at least partially forward and aft form the member 71 to define the structure and shape of wing 60. Wings 60 can have a lobe type shape having a naturally varying or irregular leading edges 66 and trailing edges 68 similar to that of many leaves, for example, or, contrastingly, leading edges 66 and trailing edges 68 can have traditional linear parallel or tapered shapes. Similarly, wing tips 62 can be straight, rounded, or pointed.

Wings 60 can be employed as a single pair or in multiple pairs. Preferably, when wings 60 are employed in multiple pairs, the pairs of wings 60 positioned aft of a first wing 60a has a greater wing length than the wing 60a positioned forward or closer to first ent 22. At least one wing 60, such as wing 60b has a forward sweep on leading edge 66 and a forward sweep on trailing edge 68. Additional wing pairs can be forward swept or non-forward swept wings depending upon the aerodynamic performance desired. The different pairs of wings 60 can be aligned relative to each other within a single plane or positioned in different planes.

A rudder 90 includes a structure 100 and an airfoil 110. Rudder 90 has a tip 92 and a root 94. Root 94 is connected to structure 30 and at least partially on body 20. Rudder 90 in one preferred embodiment at least partially extends perpendicular to first side 21 and into the relative wind. Rudder 90, however, can also be an elongate member extending from second end 24 and having a general alignment with first axis 15. Rudder 90 can be forward swept, a pair of rudders in proximity to 64, or have a “V” shape when cross-sectioned along the second axis. Rudder 90 can be confi8gured to function as a simple connecting device as well as a vertical stabilizer for airfoil assembly 10.

The attachment of wings 60 and rudder 90 to structure 30 can vary from being a rigid connection, a flexible junction, or a pivotal connection configured for rotating wing 60 about an axis. The junction of wings 60 and body 30 can include a fillet or other aerodynamic reinforcing structure.

While forward swept wings when employed as the primary lifting surface for an aircraft are inherently unstable and require advanced flight control devices for compensation, forward swept wings do have the advantageous attributes of an increased capability for maneuverability at the high angles of attack and under stall conditions beyond that of traditional aft swept wings. Forward swept wings can also have a slightly higher aspect-ratio, which leads to a further reduction of the profile drag. The beneficial aspects of forward swept wings at low airspeeds and high angles of attack occur at least partly because a stall on a forward swept wing starts at the root and proceeds outward towards the wing tip. Contrastingly, stalls begin at the wing tip and proceed inward on an aft swept wing, affecting control surfaces first. Thus, the forward swept wing benefits from root stall over tip stall because the control surfaces positioned in the vicinity of the wing tip are affected last. Thus, in conditions of light or less wind, the forward swept wing configurations have an improved ability to stay aloft and to have controlled maneuvers while aloft. Airfoil or skin 40 is preferably fabricated from a material that is suitable for its application. For example, a skin 40 can be a thin sheet material having suitable strength and flexibility for use in a kite, hang glider, parachute, or sail. Airfoil 40 can be fabricated from a man made or natural material. In addition, airfoil 40 can have multiple connected layers fully encompassing structure 20 or have a single layer. When employed as a single layer airfoil 40 would employed on first side 21 of the airfoil assembly.

Depending upon the application, structure 30, 70 and 100 can be fabricated of wood, metal, plastics such as fiberglass, composite materials, reinforced portions of the airfoil, or any combinations thereof. Structures 30 and 70 have suitable strength for their intended application of shaping airfoil 40 and sufficient flexibility for bending upon the application of a controlled degree of force. Structures 30 and 70 and 100 can define a naturally lobbed shape of a leaf or an idealized leaf shape, for example, or a man made shape such as a typical fixed winged aircraft or missile.

Control system 120 is connected with airfoil apparatus 10 for controlling the directional orientation of airfoil apparatus 10 in use. Control system 120 can include, for example, systems such as but not limited to connectors positioned for keeping the airfoil in a predefined position, surfaces configured for the control of flight such as allerons or flaps, and structural elements that can be flexed to move the structure and/or change the shape of the airfoil and thereby its flight characteristics.

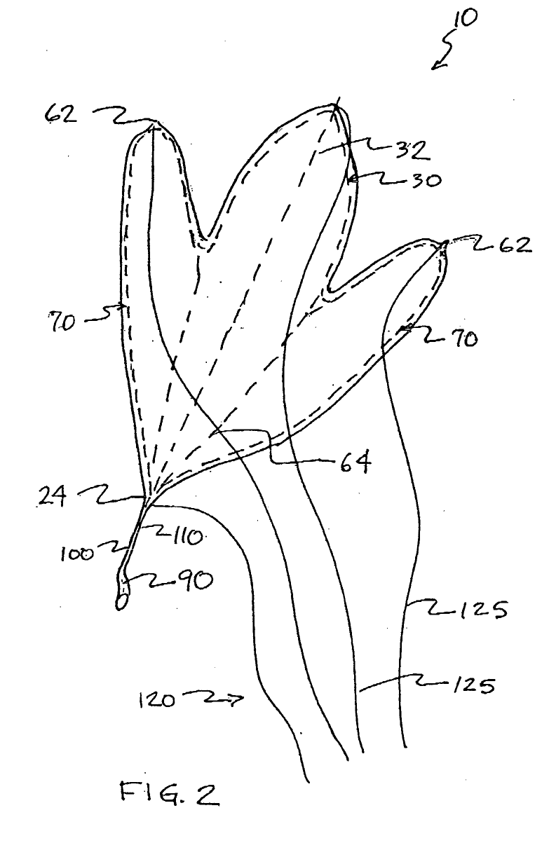

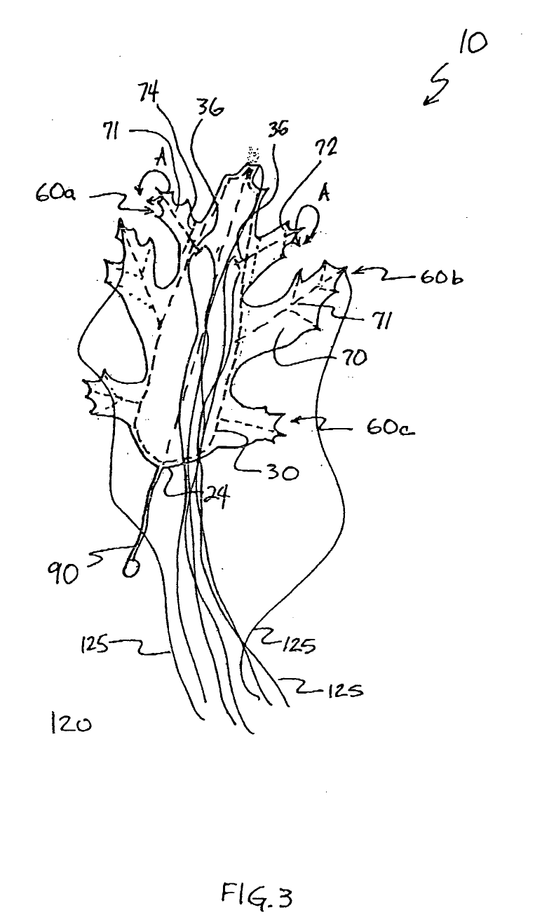

Referring now to FIGS. 2-3, in one preferred embodiment airfoil assembly 10 is configured as a kite and includes a control assembly 120 connected to key points of structure 30 and/or structure 70. While airfoil assembly 10 can have any shape advantageously including forward swept wings, airfoil assembly 10 in this one preferred embodiment has a naturally occurring or idealized leaf shaped structure having one or more pairs of lobes positioned and oriented to perform as forward swept wings 60. Airfoil assembly 10 when configured as a kite can be a simple continuous or integrated semi-rigid structure including structures 30, 70 and 100, for example, or a more complex structure in which at least one pair of wings 60 and/or rudder 90 are movable.

In one preferred embodiment, airfoil assembly 10 includes three pairs of wings 60 including a first pair of wings 60a in the general vicinity of first end 22, a second pair of wings 60b aft of center, and a third pair of wings 60c in the general vicinity of second end 24. A wing configuration having multiple pairs of wings, while not required can increase the stability of airfoil assembly 10 during flight. In this configuration, first wings 60a can be fixed or adjustable within a controlled range of angles of attack by control system 120 as shown by arrows-A. Control system 120 can be configured to actuate the angles of attack of wings 60a in this one example, individually or in parallel.

Rudder 90 in one preferred embodiment can be a continuous strip extending at least partially along the centerline 32 of airfoil assembly 10 into the relative wind with a suitable cantilevered length extending from body 20 such that longitudinal stability is enhanced. In addition, rudder 92 can extend beyond second end 24.

Control systems 120 includes a series of cords or lines 125 suitable for connecting airfoil assembly 10 and a person controlling the flight of the kite. Control lines 125 are typically positioned at first end 22 and second end 24 as well as wing tips 62. Control system 120 for wings 60 can also include a pair of rods 36 defining a third longitudinal axis. Rods 36 are configured to rotate about the third axis by the exercise of a pair of cords 125 and can include detents at selected angles to enhance control. In use, airfoil 10 begins flight preferably into the wind. The inherent instability of forward swept wings 60 are compensated by the at least three control lines 125 of control system 120 manipulated by the user. The forward swept configuration of the airfoil assembly 10 advantageously allows flight under reduced wind conditions than wind conditions than a traditional kite.

The user can let the kite and control lines 125 out with the wind and deep the kite in stable flight by keeping approximately equal tension on the wings and sufficient tension on the additional lines to sustain stable flight. The control system can selectively maintain an identical length of control lines, or this can be done manually.

Maneuvering the kite is accomplished when wings 60 are fixed by selectively increasing or decreasing the tension on one of the control line of one of the wings. Decreasing the tension on the left wing, for example, would allow that wing to be elevated by the relative wind above that of the right wing and place the kite in a right turn. By increasing or decreasing the tension of the control lines for the second end or first end relative to wings 60, the altitude of the kite can also be correspondingly adjusted.

When movable control surfaces connected by rods 36 are employed, additional control lines 125 are used to selectively rotate one or more rods 36 to move the control surfaces. Moving the control surfaces individually can effect turns and together in parallel can increase or decrease the altitude of the kite.

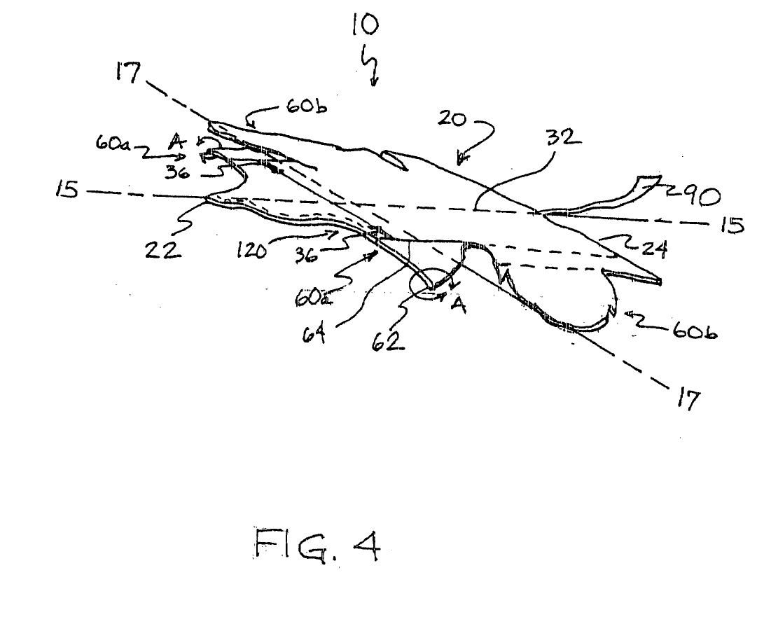

As shown in FIG. 4, airfoil assembly 10 can be configured as an airfoil for a hang glider or powered glider/plane in one preferred embodiment. Body 20 and wings 60 are preferably at least partially aligned with the first by axes 15 and 17. Wings 60 and body 20 are configured as an airfoil suitably stable for applications of slow flight.

First wing 60a is preferably a control surface or has control surfaces such as ailerons configured for rotation by rods 36 as part of control system 120. The control surfaces are connected by lines and pulleys or push and pull rod assemblies and actuated by a leg or a hand of an operator/pilot (not shown) positioned below the airfoil. Alternatively, when airfoil 10 is a fixed wing, control system 120 can establish directional control by flexing at least portions of first an/or second wings 60a and 60b. Similar also to the kite configuration, rudder 90 is positioned along centerline 32, in one preferred embodiment, extends vertically from and aft of second end 24.

A flight stability indication system can be combined with control system 120 to provide a warning through relatively simple, light weight, and small devices such as accelerometers and angle of attack indicators that can provide warning to a pilot of an impending stall or an excessively rapid acceleration that could lead to a sever attitude, for example.

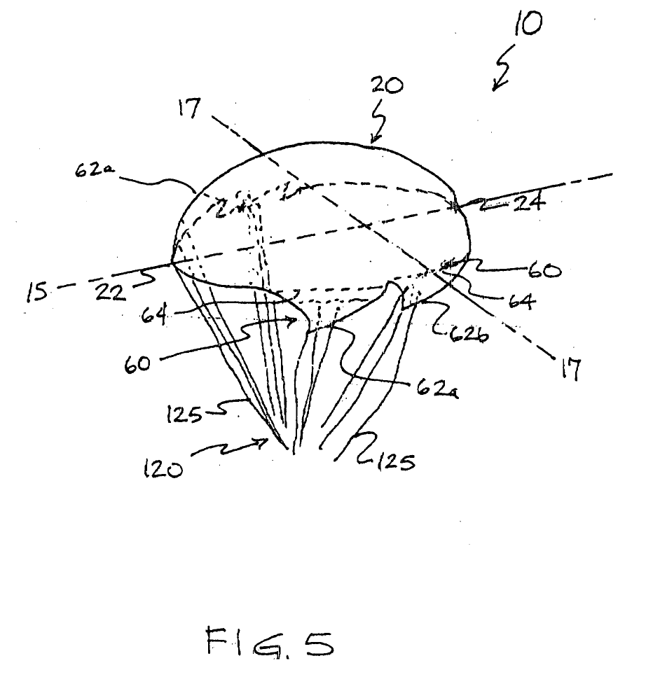

Referring now to FIG. 5, airfoil assembly 10 is shown in one preferred embodiment as a parachute wherein body 20 is configured to at least partially perform as lifting body and as a parachute. The generally hemispherical shape is configured to decelerate the vertical acceleration of the parachutist/load (not shown). Airfoil 10 also has sides, intersected by axis 17, that are slightly longer than the forward first end 22 and aft second end 24 aligned with axis 15. First end 22 and second end 24 define an arched channel to create a controlled flow of air aligned with axis 15 for forward movement.

Lobes or wings 60 are positioned to define at least a portion of the sides of the channel and to provide lift when selectively employed. Control systems 120 in this one preferred embodiment is connected with the pair of wing tips 62a and 62b at least two points of attachment further inboard or towards wing roots 64. By controlling the tension on lines 125 connected at the wing tips 62a and 62b relative to points closer to wing roots 64, forward swept wings 60 are positioned approximately parallel with the first plane defined by axes 15 and 17.

The parachute is directionally controlled by the parachutist initially positioning wings 60 generally in the first plane using control lines 125 connected to the left wing tips 62a and/or 62b. When tips 62a and/or 62b are pulled downward relative to root 64 by the parachutist using control lines 125, a turn of parachute airfoil 10 is initiated to the left similar to control system 120 of the kite and hang glider.

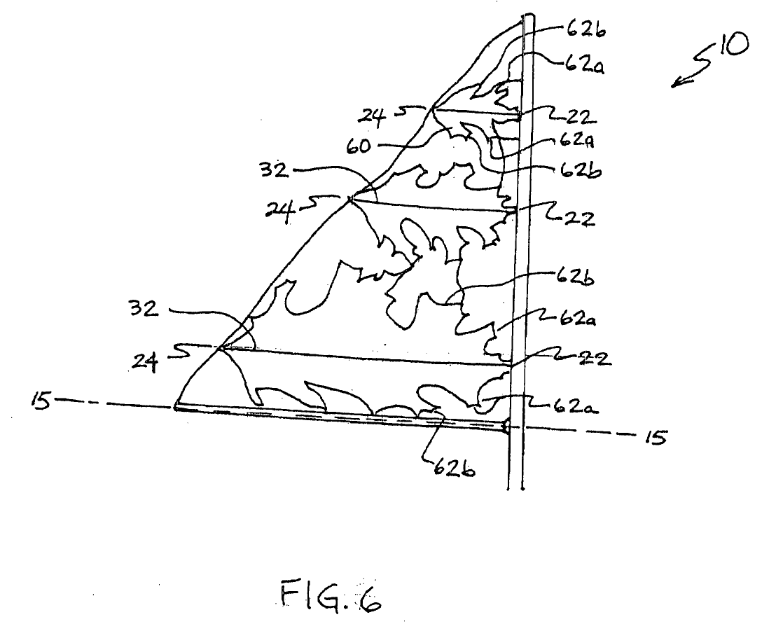

In FIG. 6, airfoil assembly 10 is configured as a sail on a wind powered vehicle such as sailboat or an iceboat. Airfoil assembly 10 is shown employed as a main sail, but it could be similarly employed as any type of sail, such as a jib, for example, or for any wind powered vehicle. In this application, multiple airfoil assemblies 10 have their first ends 22 and at least wing tips 62a connected to a line for ascending the mast. Wing tips 62 are either directly connected or interconnected using lines 125 of control system 120. At least on wing 60 is connected to the boom.

Wings 60 perform the same advantageous function wherein they have an ability to effectively translate winds having high angles of attack and/or low wind speeds into motive force better than a traditional sail. For example the presently disclosed sail would have a much less chance to luff and produce virtually no lift compared to a traditional sail. Multiple airfoils assemblies 10 are shown positioned approximately wing tip 62 to wing tip 62 with centerlines 32 aligned with first longitudinal axis 15. Structure 30 has reinforced portions of sail along centerlines 32 and provides sufficient rigidity for each airfoil to remain outstretched. Each airfoil assembly 10 does not have a requirement for wings 60 to have symmetry. First ends 62 are directly connected to the mast line. Seconds ends 64 can also be connected to an aft end of the sail, as required, to form the traditional triangular shaped sail.

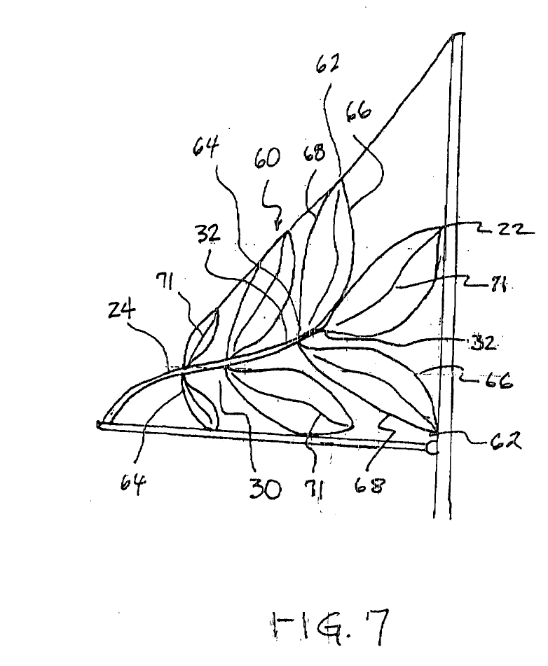

As shown in FIGS. 6-7, sails having porosity, such as ones having multiple airfoil assemblies 10 or a single compound airfoil assembly 10 are aptly suited as storm or high wind sails providing a reduced amount of surface area, but maximizing the lift of the retained surface areas to provide directional and motive benefits of a sail.

Airfoil assembly 10 in this embodiment can also have the structure and shape of a compound leaf with a first end 22 and a second end 24. Wings 60 have tips 62 and bases 64 with forward sweeping leading edges 66, trailing edges 68, and a structural centerline 71. Wing tips 62 and wing root 64 are tapered. Centerline 32 connects each wing 60.

Control portion 120 connects first end 22, second end 24, and wing tips 62 to the mast and boom using means commonly employed by sails such as grommets and latching devices. The amount of reduced surface area fro airfoil 10 depends on the desired configuration. It is readily envisioned that airfoil 10 as a sail can range from overlapping leaf portions providing a substantially full sail, for example, to having substantial gaps between forward swept wings 60. Airfoil 10 can advantageously provide improved lift forces through its range of configurations as a result of its forward swept configuration.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing form the scope or spirit of the disclosure. All such changes and modifications are intended to be included within the scope of the disclosure.

1. A multipurpose airfoil assembly comprising:
an airfoil assembly having a body including a first end and a second end, the first and the second end defining a first longitudinal axis, the body including a structure and a skin, the structure having at least on member aligned with the longitudinal axis;
at least on pair of wings connected to the body, the wings including a wing structure and a wing airfoil, one of the wings having a forward sweeping leading edge and forward sweeping trailing edge, the body and wings defining a leaf shaped airfoil assembly; and,
a control system configured for controlling the directional alignment if the airfoil assembly.

2. The airfoil assembly of claim 1, wherein the airfoil assembly is a kite, the control system including lines suitable positioned of directionally controlling the kite by a person.

3. The airfoil assembly of claim 2, wherein the leaf shape of the airfoil has lobes suitable positioned and configured as wings.

4. The airfoil assembly of claim 3, wherein at least one wing is connected by a pivot to the body, the position of the wing being controlled by the control system.

5. The kite assembly of claim 3, wherein the kite has a rudder assembly including a rudder structure and a rudder airfoil, the rudder being aligned with the longitudinal axis.

6. The airfoil assembly of claim 5, wherein the airfoil assembly has a first side and the rudder is positioned on the first side.

7. The airfoil assembly of claim 3, wherein the control system includes at least three lines connected to the wing tips and body.

8. The airfoil assembly of claim 3, wherein the skin covers at least the first side of the structure.

9. The airfoil assembly of claim 1, wherein the airfoil assembly is a sail.

10. The airfoil assembly of claim 1, wherein the airfoil assembly is a hang glider.

11. The airfoil assembly of claim 10, wherein the airfoil assembly the shape of a leaf, the leaf having lobes suitably positioned and configured as wings and the control system includes a series of lines connected to a pair of wings configured for pivoting.

12. The airfoil assemble of claim 10, wherein the airfoil assembly includes a rudder.

13. The airfoil assembly of claim 11, wherein the airfoil assembly is a parachute.

14. A multipurpose forward swept wing airfoil assembly comprising:
an airfoil assembly having a body including a first end and a second end defining a first longitudinal axis, the body including a structure and skin, the structure having at least one member aligned with the longitudinal axis second axis perpendicular to the longitudinal axis, the skin defining a lifting body generally having a flexible shape;
at least one pair of wings including a wing structure and a wing airfoil, a first pair of wings being at least partially swept, the wing structure being positioned for movement in general alignment with airfoil assembly, each wing including a wing tip, the wing and the body defining a leaf shape; and,
a control system including at least three continuous flexible elements, the at least there flexible elements being connected to the wing tips and the body, the flexible elements being arranged to direct the movements of the wings and body of the airfoil assembly.

15. The airfoil assembly of claim 14, wherein the airfoil assembly is a sail having the shape including at least one leaf, each leaf having lobes suitably positioned and configured as wings.

16. The airfoil assembly of claim 15, wherein the control system is a series of connectors configured for positioning the sail in a position suitable for providing motive force to a wind powered vessel.

17. The airfoil assembly of claim 14, wherein the sail is configured as a kite.

18. The airfoil assembly of claim 14, wherein the sail is configured as a hang glider.

19. The airfoil assembly of claim 14, wherein the airfoil is a parachute.

20. The airfoil assembly of claim 18, wherein the shape of the airfoil includes at least one leaf the at least one having lobes positioned as lifting surfaces.

21. The airfoil assembly of claim 18, wherein the first end and the second end can be expanded and contracted to control the shape of the parachute along the first axis to control the forward speed of the parachute.
